(19) United States
(12) Patent Application Publication
(10) Pub. No.: US 2026/0293866 A1
(43) Pub. Date: Oct. 1, 2026

(54) CLAMMING QUIVER

(71) Applicant: COLLIN NOORTMANN CHANDLER, ASTORIA, OR (US)

(72) Inventor: COLLIN NOORTMANN CHANDLER, ASTORIA, OR (US)

(21) Appl. No.: 19/097,290

(22) Filed: Apr. 1, 2025

(51) Int. Cl. A01K 80/00

(52) U.S. Cl. CPC A01K 80/00

(57) ABSTRACT

A cylindrical device used to conveniently hold, carry, and transport both a clam gun and harvested clams. One or more handles and/or straps are used for ease of carrying. One or more conveniences may be added, such as a sand anchor and count keeper.

### BACKGROUND/SUMMARY

### Background

Many devices for harvesting or “digging” clams exist. Among recreational harvesters, the most popular alternative to a simple shovel is the “clam gun”, a cylindrical tool, open at the bottom end and closed at the top with a handle and air vent hole. It is used to push down into sand over visible signs of a clam, then cover the air vent and draw up the tube full of sand and therein, with luck, the clam. Some people also carry a “thumper”, a filled pipe or large stick, to startle and cause the clam to “show”, via a gush of water up through the sand. Most clam gun users then employ a mesh “clam bag” or common bucket to hold any harvested clams. Clam guns are manufactured in some variety, using differing materials, designs, lengths and widths. They are a popular and useful tool, but can be unwieldy and/or heavy when carried to the beach and then while searching for clams. (Clam guns and improvements thereof have been patented since, at least, the mid-twentieth century, see U.S. Pat. No. 2,802,689 March 1957, Batstone; U.S. Pat. No. 3,089,721 December 1960, Pucket; U.S. Pat. No. 4,244,614 January 1981, Madsen.)

This quiver device enables the user to: (a) carry the clam gun hands-free while walking, hiking or even biking to the beach, (b) securely set the clam receptacle vertically into the sand and shallow surf while thumping or digging, (c) manually keep count of harvested clams to observe legal limits, (d) compactly carry back both the clam gun and the harvested clams, without damaging either.

### SUMMARY

The essential device disclosed is comprised of two concentric cylinders with open top ends and a shared, closed bottom. The space between the inner and outer cylinder must be wide enough to allow the opposing cylinder of a clam gun to slip down between them from the top, coming to rest either at the bottom of the device or with its upper taper against the top of the inner cylinder. The inner cylinder must be shorter than the outer cylinder, but wide enough and tall enough to accommodate harvested clams.

Near the upper rim of the outer cylinder, a handle, handles, or handle holes are necessary, as is a carrying strap.

A configuration of two sets of opposing horizontal guide slots, one just below the other, on each side of the outer cylinder, near the top, as well as a line of attachment points down one or both sides of the cylinder offer a great number of strap placement options and configurations. These include: securely “nesting” the clam gun for handle-strap suitcase-style carrying, over-the-shoulder carrying, behind-the-back carrying, or twin shoulder-straps backpack-style carrying. The connection points can be as simple as twin tabs cut from the outer cylinder by cutting/forming a channel in the shape of the capital letter “E”.

Without an anchoring mechanism, the device will not stand upright if set down on soft sand or in the path of shallow waves. In optional embodiments, this can be mitigated in a few ways. First, the bottom of the outer cylinder can be formed to create pointed protrusions for pushing down into the sand to the level of the inner cylinder bottom. Alternately, a pointed, non-corrosive, bolt rod and sleeve can be attached vertically to the outer cylinder. Perhaps best, a non-corrosive rod can be bent into a shape that creates two downward anchor rods connected by a curved handle. This configuration can then be fitted into two vertical slots in the outer cylinder with the bottom of both anchor rods set into two aligned holes in the bottom of the devise. The rods can then be extended and retracted using the handle. If two vertical tabs are cut from the outer cylinder, facing away from each other, toward the top and bottom of the handle's range. (The tab ends can be formed or raised using heat or an off-set plate.) These tabs will then hold the handle in place, whether extended or retracted, and the tab need only be pressed in to release it.

Additionally, the top rim of the outer cylinder can be etched or otherwise marked with sequential numerals with or without a checkerboard background. An interior, exterior, or double-sided groove can be used to attach a sliding marker and thus used to tally clams as they are harvested.

Finally, the outer cylinder is well suited to decoration and/or licensed branding, images, and logos.

### DESCRIPTION

### Brief Description of the Drawings

FIG. 1 is a perspective view of an embodiment of the clam harvesting accessory device with a slide-bolt anchor. Above it is a depiction of a clam gun as it would slip down between the two cylinders of the devise.

FIG. 2 is a perspective view of an embodiment of the clam harvesting accessory device featuring a protruding handle, a shoulder strap anchored at the top of the outer cylinder from two opposing holes, and sand anchor protrusions formed from the body of the outer cylinder. It is shown with a nested clam gun.

FIG. 3 is a perspective view of an embodiment of the clam harvesting accessory device featuring guide slots and tab slots for the variable strap, and a twin rod, retractable anchoring system.

FIG. 4 is an overhead view of the clam harvesting accessory device with a variable strap configuration securing a long-bodied, un-tapered clam gun.

FIG. 5 is an overhead view of the clam harvesting accessory device with a variable strap configuration securing a short-bodied, tapered clam gun.

FIG. 6 is an overhead view of the clam harvesting accessory device with a variable strap configured to secure a short-bodied, tapered clam gun and form two shoulder straps.

FIG. 7 is a is a perspective view of an embodiment of the clam harvesting accessory device featuring opposing guide slots and tab-style anchors for a strap. (Strap not shown)

FIG. 8 is a is a perspective side view and detailed view of an embodiment of the clam harvesting accessory device featuring a strap employing the guide slots and tab slots shown in FIG. 7.

FIG. 9 is a perspective and detailed view of an embodiment of the clam harvesting accessory device featuring a twin-rod retractable anchoring system. (Rods retracted)

FIG. 10 is a detailed side view of the twin-rod retractable anchoring system shown in FIG. 9. (Rods extended)

FIG. 11 is a perspective view of a single metal rod configured to be used as a twin-rod anchor and handle within the embodiment shown in FIG. 9 and FIG. 10.

FIG. 12 is a perspective and detailed view of an embodiment of the clam harvesting accessory device featuring sequential numerals and a sliding marker.

### DETAILED DESCRIPTION

The following detailed description is of the currently contemplated modes of carrying out embodiments of the invention, for the purposes of illustrating the general principles of the invention, and should not be seen in a limiting sense.

In general, this cylindrical device provides practical solutions as an accessory to a clam gun or similar clam harvesting implement, to carry the implement itself, as well as any harvested clams. Embodiments may further provide solutions for anchoring the device vertically in sand and keeping count of the harvested clams.

FIGS. 1-3 illustrate three potential and differing embodiments of the core concentric cylinder design. As seen in all embodiments, a smaller and shorter interior cylinder 2 sits rigidly inside a taller and wider exterior cylinder 1. Both cylinders are closed at the bottom and open at the top. The interior space of the inner cylinder 2 is used to contain harvested clams. The space between the inner and outer cylinders is used to nest the opposing cylinder of the clam gun 3 or similar implement. The inner and outer cylinders, as well as the bottom could be fabricated from a variety of materials such as aluminum or stainless steel, but prototypes have been formed from polyvinylchloride (PVC) cylinders set into a bottom of epoxy resin.

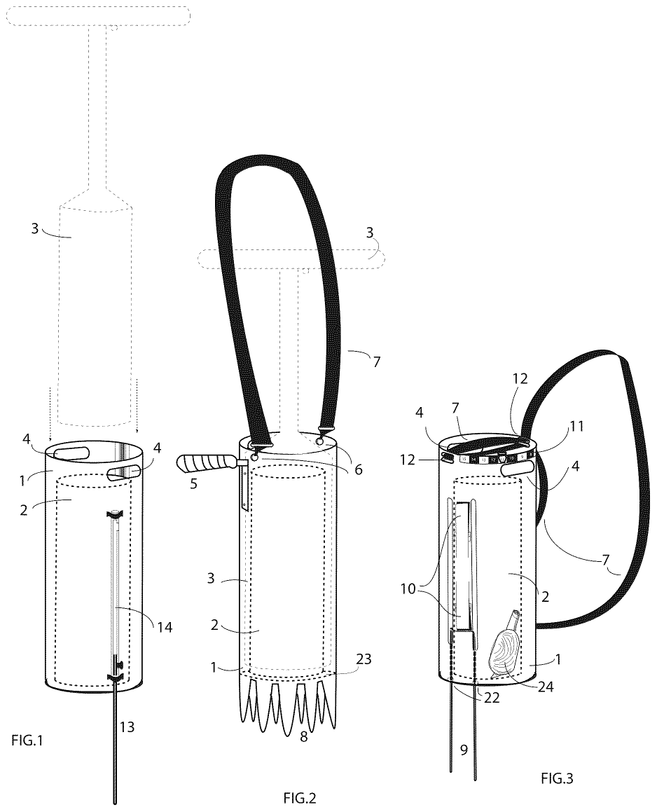

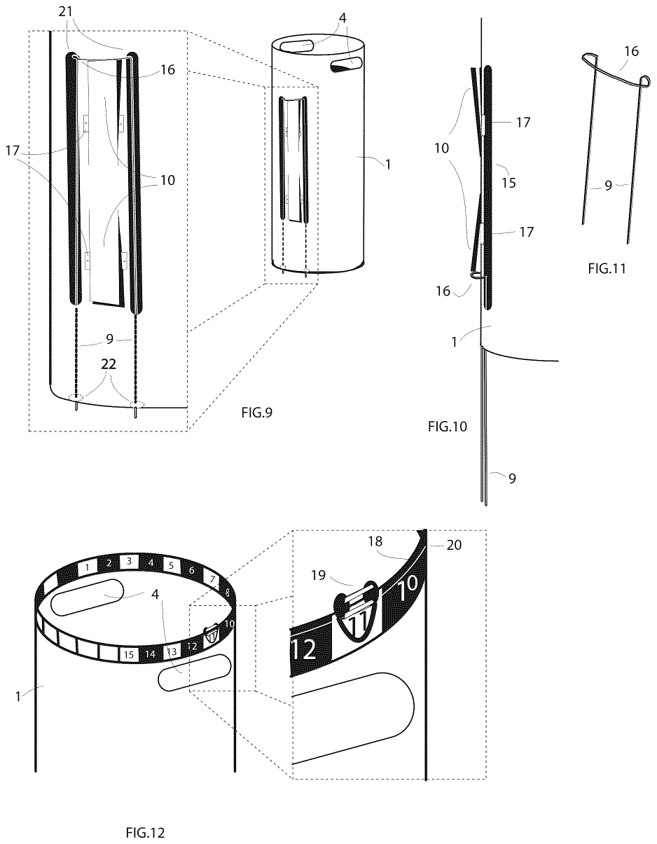

FIGS. 1-3 each show a different embodiment of the core invention with regard to hand holes, handles, straps, anchors, and tally system. FIG. 1 shows the core invention configured with two opposing hand holes 4 near the top of the outer cylinder 1, and a retractable slide bolt anchor attached to the side of said outer cylinder. FIG. 2 displays the core invention configured with an exterior handle 5 attached to the upper end of the outer cylinder 1, as well as a simple strap 7 fastened with clips via two opposing holes 6 near the top of said outer cylinder, and a set of anchoring prongs 8 formed from the body of said exterior cylinder. FIG. 3 details an embodiment of the core device wherein opposing guide slots 12 and multiple attachment points (not shown, see FIG. 7) are used to configure the strap 7 to the exterior cylinder 1, as well as opposing hand holes 4, a retractable twin-rod anchoring system (see FIGS. 9-10), and a tally system 11 (see FIG. 12). A razor clam 24 is illustrated within the inner cylinder 2.

Not all clam guns are designed identically. Variations include the width (diameter) of the main cylinder (generally four or five inches) and whether or not the full width of that cylinder extends the full height of the implement (right up to the handles). Most aluminum or stainless steel models of clam gun taper the main cylinder to a width matching the width of the handles. The taper usually occurs at a height of twelve to twenty-four inches from the bottom. Clam guns also come in a range of heights, generally between twenty-four and forty inches tall, and some employ a vacuum vent mechanism (essentially a small pipe or vent tube) that extends the full length of the main cylinder. Bearing these variations in mind, a balance must be struck in choosing widths (diameters) of the two concentric cylinders that substantially comprise the invention. The inner cylinder 2 must be wide enough and tall enough to accommodate harvested clams, but not so wide as to disallow the nesting of the clam gun. Constructing the invention to create a perfect fit for a specific model of clam gun is certainly possible, but so is creating embodiments that accommodate many or most models of clam gun, albeit less snugly.

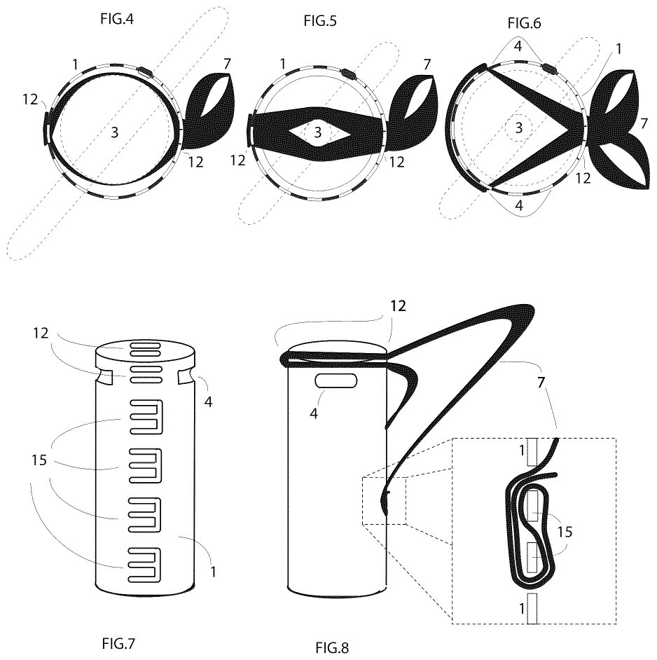

FIGS. 4-8 demonstrate how an embodiment that includes opposing guide holes 12, hand holes 4, and attachment tabs 15 can be used in conjunction with a strap 7 to secure a variety of clam gun designs. FIG. 4 is an overhead illustration of how a strap would “hug” an un-tapered (constant width) clam gun 3. FIG. 5 shows how a tapered (dual width) clam gun 3 would be held securely at the level of the taper. FIG. 6 displays how the strap could be configured using guide slots 12, hand holes 4, and the exterior surface of the outer cylinder 1 to create angled twin shoulder straps for backpack style carrying. FIG. 7 exhibits the configuration of the opposing guide slots 12, the attachment tabs 15, and hand holes 4, these holes and channels have been cut or formed from the body of the outer cylinder 1. FIG. 8 provides a side view of a strap 7 threaded through all four guide slots 12 with both ends of the strap 7 attached at two different tabs 15. The detail illustrates how the end of the strap 7 is threaded around and between tabs 15 to secure it.

FIGS. 9-11 reveal an embodiment with a twin rod anchoring system incorporated into the outer cylinder 1 and through the closed bottom 23. The detail in FIG. 9 illustrates two vertical slots 21 in the outer cylinder 1, and two holes 22 in the bottom plate 23 near the outer cylinder 1 wall. In-between those vertical slots 21 are two vertical tabs 10, one oriented upward and the other down. Both tabs 21 have been off-set at opposing ends outward from the body of the cylinder 1 by means of a back-plate 17. These back-plates 17 have been wedged and secured behind the tabs 21, but in front of the cylinder 1 wall. The raised ends of the off-set tabs 21 are used to hold the handle 16 of the twin rods 9 in place, whether retracted or extended (shown retracted). FIG. 10 is a side view of the same (shown extended). FIG. 11 illustrates how a single length of metal rod is bent and formed into the handle 16 and the twin anchor rods 9.

FIG. 12 displays an embodiment which includes an etched, or formed, or otherwise applied sequence of numerals 18 around the upper (open) rim of the outer cylinder 1. A sliding marker 19 is then fastened along the top edge into shallow grooves 20 that circle one or both sides of the outer cylinder 1.

### FIELD OF SEARCH

### CPC

A01K80/00 (harvesting oysters, mussels, sponges or the like);
A10K 97/20 (keepnets or other containers for keeping captured fish);
A45F 3/02 (Sack or packs carried on the body by means of one strap passing over the shoulder);
A45F 3/14 (Carrying-straps; Pack-carrying harnesses);
B65D 5/46024 (straps used as handles with anchoring elements fixed in slots);
B65D 5/4608 (hand grip holes);
B65D 11/16 (Containers having bodies formed by interconnecting or uniting two or more rigid, or substantially rigid, components made wholly or mainly of plastics material with double walls)

### USPC

43/21.2 (Fishing, trapping and vermin destroying/Holder, supports, steadying devices);
43/54.1 (Fishing, trapping and vermin destroying/Holder);
224/44.5 (Package and article carriers/Fish or game stringer or holder therefor);
224/578 (Package and article carriers/Having rearrangeable strap);
224/629 (Package and article carriers/Rigid or semi-rigid container);
224/678 (Package and article carriers/Rigid receiver);
224/679 (Package and article carriers/Rigid materials form container);
224/257 (Package and article carriers/Flaccid attaching means looped around neck or shoulder)

### SEARCH HISTORY AND FINDINGS

USPTO—Patent Public Search online tool used extensively for CPC, USPC and keyword searches. Search terms and combinations thereof included, but were not limited to: Clam, Clamgun, Clam Gun, Clam-gun, Clamming, Digger, Clam-digger, Digger, Cylinder, Cylindrical, Holder, Quiver, Carrier, Pack, Shellfish, Mollusk, Bi-valve, Strap, Counter, Tally, Tallies, Receptacle, Anchor, Sand-anchor, System, Keeper, Bag, Accessory, Holster, Harvester, Container, Razor, Tool, Equipment, Bucket, Case, Net Bag, Storage.
   Findings—relevant results are listed in “References Cited; US Patent Documents”.
Espacenet—European Patent Office online public search tool-searched relevant combinations of CPC codes and keywords, such as: Clam, Clam Gun, Digger, Bag, Cylinder, Harvester, Holder, Carrier, etc.
   Findings—one relevant result is listed in “References Cited; Foreign Patent Documents”.
Google Images—Searched using combinations of keywords such as: Clam, Clam Gun, Dig, Digger, Bag, Cylinder, Harvest, Holder, Carrier, Bucket, etc.
   Findings—Extensive Image review of products, beach scenes, clamming videos, catalogs stills, and much more, revealed nothing similar to this invention.
Amazon.com—Searched using combinations of keywords such as: Clam, Clam Gun, Digger, Bag, Cylinder, Harvester, Quiver, Holder, Carrier, Bucket, etc.
   Findings—included clam guns, collapsible fishing and bait buckets or “wells”, shotgun quivers, and rigid cylindrical archery quivers, but nothing significantly similar to this invention.
eBay.com—Searched using combinations of keywords such as: Clam, Gun, Clam-gun, Digger, Bag, Cylinder, Harvester, Quiver, Kwivver, Tool, Carrier, Bucket, Case, etc.
   Findings—included clam guns, clam shell pistol cases, arrow tube cases, etc, but nothing significantly similar to this invention.
YouTube.com—Searched videos using combinations of keywords such as: Clam, Clamming, Clam Gun, Razor clam, Digging, etc.
   Findings—No video showed any device or implement appearing similar to this invention, except for smaller versions of the “Geoduck Tube”, a large cylindrical tube used to keep sand from falling back into a hole while digging for the geoduck clam.
Various Marine and Sporting Supply Websites—Search terms included: Clam, Clam-gun, Clamming, Equipment, Accessory, Accessories, Quiver, Holder, etc.
   Findings—included clam bags, clam guns, geoduck tubes, buckets, etc., but nothing significantly similar to this invention.

### REFERENCES CITED

### Us Patent Documents

Relating to Clam Guns, Clam Diggers, and the like:

| Patent No. | | Issued Date | Patentee Name | USPC or CPC |
|---|---|---|---|---|
| 1,696,371 | A | February 1928 | Wallace | |
| 2,802,689 | A | August 1957 | Batstone | 294/50.7 |
| 3,089,721 | A | May 1963 | Puckett | 294/50.7 |
| 3.372.496 | A | November 1964 | Lawlis | 294/50.7 |
| 4,244,614 | A | January 1981 | Madsen | A01B 1/00 |
| 4,489,969 | A | December 1984 | Merry | A01B 1/18 |
| 2016/0088820 | A1 | March 2016, | Blankenship | A01K 80/00 |
| | | | et al. | |

Relating to CPC or USPC classification and key word search results:

| Patent No. | | Issued Date | Patentee Name | USPC or CPC |
|---|---|---|---|---|
| 268,558 | A | December 1882 | Small | |
| 2,241,314 | A | August 1940 | Mohler | |
| 3,674,188 | A | July 1972 | Anderson | A45F 3/02 |
| 4,498,190 | A | February 1985 | Garlick | B65D 33/01 X |
| 4,570,374 | A | February 1986 | Baxley | A01K 97/04 |
| 4,775,082 | A | October 1988 | Krache | A45F 3/14 |
| 5,634,291 | A | June 1997 | Pham | A01K 97/05 X |
| 5,755,057 | A | May 1998 | Dancer | A01K 97/00 |
| 5,802,760 | A | September 1998 | Campbell | A01K 97/05 |
| 6,345,744 | B1 | February 2002 | Eldridge | A45F 4/02 X |
| 2005/0268527 | A1 | December 2005 | Beech | A01K 97/05 X |
| 2008/0087696 | A1 | April 2008 | Sublett | A45F 3/14 X |
| 7,444,688 | B2 | November 2008 | Sublett | A41F 19/00 |
| 7,631,754 | B1 | December 2009 | Fickett | B65D 85/00 X |
| 8,479,939 | B1 | July 2013 | Gross | A01K 97/04 X |
| 8,756,856 | B1 | June 2014 | Girvin | A01K 97/20 |
| 2015/0082686 | A1 | March 20015 | Merritt | A01K 97/20 X |
| 9,463,902 | B2 | November 2016 | Daniels et al. | B65D 25/00 X |
| 10,070,638 | B2 | September 2018 | Volk | A01K 97/05 X |
| 10,098,335 | B2 | October 2018 | Cooper | A01K 97/04 X |
| 10,660,323 | B1 | May 2020 | Sharrow | A01K 97/05 |
| 10,888,078 | B2 | January 2021 | Burts et al. | A01K 97/08 X |
| 11,779,002 | B2 | October 2023 | Davidson | A01K 97/20 X |
| 11,814,857 | B2 | November 2023 | Reinhardt | E04H 12/22 X |

### Foreign Patent Documents

| Patent No. | Issued Date | Patentee Name | USPC or CPC |
|---|---|---|---|
| CN 216415708u | October 2021 | Liu | A01K 80/00 |

1. A clam harvesting accessory device comprising: a rigid exterior cylinder open on the top end and closed on the bottom end; a narrower interior cylinder mounted concentrically inside said (exterior) cylinder at the said closed (bottom) end; a handle or handles; and/or a carrying strap.

2. A clam harvesting accessory device as in claim 1, wherein said strap can be adjusted and configured using multiple, opposing handle holes and guide-slits at the said open (top) end of said exterior cylinder, and multiple fastening points down one or both sides of said exterior cylinder.

3. A clam harvesting accessory device as in claim 1, wherein the upper rim of the said external cylinder is labeled with sequential numerals and a sliding marker is thereon attached.

4. A clam harvesting accessory device as in claim 1, wherein an anchoring system, such as a slide bolt, or metal rods, or fixed protrusions extend downward from the said closed end (bottom) of said exterior cylinder.

5. A clam harvesting accessory device as in claim 4, wherein said anchoring rods can be raised or lowered and locked into either position via raised vertical tabs off-set from said external cylinder.
